(19) United States
(12) Patent Application Publication
(10) Pub. No.: US 2007/0155847 A1
(43) Pub. Date: Jul. 5, 2007

(54) High surface area activated carbon foam

(76) Inventors: Douglas J. Miller, North Olmstead, OH (US); Irwin C. Lewis, Strongsville, OH (US); Richard L. Shao, North Royalton, OH (US); Terrence A. Pirro, Cleveland, OH (US)

Correspondence Address: WADDEY & PATTERSON, P.C., 1600 DIVISION STREET, SUITE 500, NASHVILLE, TN, 37203, US

(21) Appl. No.: 11/321,757

(22) Filed: Dec. 29, 2005

(51) Int. Cl. C08G 63/00

(52) U.S. Cl. 521/180

(57) ABSTRACT

An activated carbon foam material with improved graphitizability is formed by including an oxidation promoting metal-containing additive into the carbon foam and subsequently heat treating the foam in a reactive atmosphere. The oxidation promoting metal-containing additive greatly improves the development of the carbon foam's ramified pore system resulting in a carbon foam with a much greater surface area. This inventive foam may be created by introducing the oxidation promoting metal by way of an oxidation catalyst during the polymerization of the phenolic resin or as a inorganic chemical activating agent to the formed phenolic resin. The foam is then heated in a reactive atmosphere to produce an activated foam with a surface area of from about 200 m²/g to about 3000 m²/g.

### BACKGROUND OF THE INVENTION

1. Technical Field

The present invention relates to activated carbon foams useful for purification and separation processes such as the decontamination of waste water or the separation of gas mixtures. More particularly, the present invention relates to carbon foams exhibiting superior strength, weight and density characteristics while possessing a larger overall surface area. The invention also includes methods for the production of such foams.

2. Background Art

Carbon foams have attracted considerable recent activity because of their properties of low density, coupled with either very high or low thermal conductivity. Conventionally, carbon foams are prepared by two general routes. Highly graphitizable foams have been produced by thermal treatment of mesophase pitches under high pressure. These foams tend to have high thermal and electrical conductivities. For example, in Klett, U.S. Pat. No. 6,033,506, mesophase pitch is heated while subjected to a pressure of 1000 psi to produce an open-cell foam containing interconnected pores with a size range of 90-200 microns. According to Klett, after heat treatment to 2800° C., the solid portion of the foam develops into a highly crystalline graphitic structure with an interlayer spacing of 0.366 nm. The foam is asserted to have compressive strengths greater than previous foams (3.4 MPa or 500 psi for a density of 0.53 g/cc).

In Hardcastle et al. (U.S. Pat. No. 6,776,936) carbon foams with densities ranging from 0.678-1.5 g/cc are produced by heating pitch in a mold at pressures up to 800 psi. The foam is alleged to be highly graphitizable and provide high thermal conductivity (250 W/m° K).

According to H. J. Anderson et al. in Proceedings of the 43d International SAMPE Meeting, p 756 (1998), carbon foam is produced from mesophase pitch followed by oxidative thermosetting and carbonization to 900° C. The foam has an open cell structure of interconnected pores with varying shapes and with pore diameters ranging from 39 to greater than 480 microns.

Rogers et al., in Proceedings of the 45^{th} SAMPE Conference, pg 293 (2000), describe the preparation of carbon foams from coal-based precursors by heat treatment under high pressure to give materials with densities of 0.35-0.45 g/cc with compressive strengths of 2000-3000 psi (thus a strength/density ratio of about 6000 psi/g/cc). These foams have an open-celled structure of interconnected pores with pore sizes ranging up to 1000 microns. Unlike the mesophase pitch foams described above, they are not highly graphitizable. In a recent publication, the properties of this type of foam were described (High Performance Composites September 2004, pg. 25). The foam has a compressive strength of 800 psi at a density of 0.27 g/cc or a strength to density ratio of 3000 psi/g/cc.

Stiller et al. (U.S. Pat. No. 5,888,469) describes production of carbon foam by pressure heat treatment of a hydrotreated coal extract. These materials are claimed to have high compressive strengths of 600 psi for densities of 0.2-0.4 g/cc (strength/density ratio of from 1500-3000 psi/g/cc). It is suggested that these foams are stronger than those having a glassy carbon or vitreous nature which are not graphitizable.

Carbon foams can also be produced by direct carbonization of polymers or polymer precursor blends. Mitchell, in U.S. Pat. No. 3,302,999, discusses preparing carbon foams by heating a polyurethane polymer foam at 200-255° C. in air followed by carbonization in an inert atmosphere at 900° C. These foams have densities of 0.085-0.387 g/cc and compressive strengths of 130 to 2040 psi (ratio of strength/density of 1529-5271 psi/g/cc).

In U.S. Pat. No. 5,945,084, Droege described the preparation of open-celled carbon foams by heat treating organic gels derived from hydroxylated benzenes and aldehydes (phenolic resin precursors). The foams have densities of 0.3-0.9 g/cc and are composed of small mesopores with a size range of 2 to 50 nm.

Mercuri et al. (Proceedings of the 9^{th} Carbon Conference, pg. 206 (1969)) prepared carbon foams by pyrolysis of phenolic resins. For foams with a density range of 0.1-0.4 g/cc, the compressive strength to density ratios were from 2380-6611 psi/g/cc. The pores were ellipsoidal in shape with pore diameters of 25-75 microns) for a carbon foam with a density of 0.25 g/cc.

Stankiewicz (U.S. Pat. No. 6,103,149) prepares carbon foams with a controlled aspect ratio of 0.6-1.2. The patentee points out that users often require a completely isotropic foam for superior properties with an aspect ratio of 1.0 being ideal. An open-celled carbon foam is produced by impregnation of a polyurethane foam with a carbonizing resin followed by thermal curing and carbonization. The pore aspect ratio of the original polyurethane foam is thus changed from 1.3-1.4 to 0.6-1.2.

Rogers et al. (U.S. Pat. No. 6,833,011) creates an activated carbon foam through the treatment of coal-based carbon foam with an oxidizing gas. The resulting activated coal-based carbon foam is described as having an overall surface area ranging from about 10 m²/g to about 25 m²/g.

Commercially, activated carbons are used for a wide range of applications including filtration, waste water treatment, food and chemical processing, gas separation, gasoline emission control, catalyst supports, molecular sieves, gas storage and super capacitors. Commercial activated carbons require high surface areas well in excess of 100 m²/g, usually 500-2000 m²/g. (Active carbons in Kirk-Othmer Encyclopedia of Chemical Technology, 4^{th} Edition; p. 1015 (1992)). Commercial activated carbons have some serious economic and environmental disadvantages which make them unsuitable for many applications. Most commonly, activated carbon is produced in the form of particulates, requiring the use of a containment unit which adds cost, weight, and can lead to environmental issues. Furthermore, these particles are especially difficult to handle as they are quite dusty and potentially hazardous to human health. The active carbon particulates can be formed into pellets or monoliths by extrusion or molding with an non- activated binder.

The prior art process of creating carbon monoliths by combining a binder with active carbon powder or granules and then either extruding or molding the composition to create an active carbon monolith is disadvantageous as it includes extra processing steps and also increases the weight of the active carbon monolith. Furthermore, binder created carbon monolith exhibits an overall decreased activity due to the binder not contributing to the monolith's active surface area while simultaneously blocking the porosity of the active carbon.

The Rogers et al. activated, coal-based carbon foam solved a few of the problems associated with particulate style activated carbon, but that foam, having a surface area of from about 10 m²/g to about 25 m²/g, does not have a high enough surface area for any commercial applications. Also, the energy costs associated with the Rogers et al. foam are high as activating a coal-based carbon foam requires passing reactive gas through the foam at very high temperatures for an extended time period. Specifically, the reference discusses activating carbon foam with carbon dioxide at 900° C. for up to 6 hours whereby a carbon foam is created with only a surface area of from about 10 m²/g to about 25 m²/g.

What is desired, therefore, is an activated carbon foam which is monolithic and has a controllable cell structure, where the cell structure, and high surface area make the foam suitable for a variety of activated carbon foam applications including filtration, food and chemical processing, waste water treatment, gasoline emission control, gas separation, gas storage, molecular sieves, and catalyst supports. The low density and monolithic structure of this activated carbon would provide significant economic and energy savings advantages for active carbon applications. Additionally, this inventive high surface area activated carbon foam possesses characteristics that make the foam suitable for use as a supercapacitor. Furthermore, this invention can be lead to activation processes which can be carried out at lower temperatures than the prior art allowing for a decreased energy expenditure. The glassy carbon (non-graphitizing) nature of the carbon foam plus the presence of oxidation enhancing metal catalysts make the foam very easy to activate so that activation of the inventive carbon foam can be achieved at lower temperatures with shorter reaction times than conventional prior art thermal activation processes. Indeed, a combination of characteristics, including an improved surface area higher than contemplated in the prior art, have been found to be necessary for use of a carbon foam in purification and separation applications. Also desired is a process for preparing such foams.

### SUMMARY OF THE INVENTION

The present invention provides a carbon foam which exhibits improved surface area, density, conductivity and relatively light weight characteristics not heretofore seen. In addition, the monolithic nature and bimodal cell structure of the precursor carbon foam, with a combination of larger and smaller pores, which are relatively spherical, provide a carbon foam which can be produced in a desired size and configuration and which can be readily machined.

More particularly, the inventive carbon foam, prior to activation, has a density of about 0.05 to about 0.4 grams per cubic centimeter (g/cc), with a compressive strength of at least about 2000 pounds per square inch (psi) (measured by, for instance, ASTM C695). An important characteristic for the foam when intended for use in a high temperature application is the ratio of strength to density. For such applications, a ratio of strength to density of at least about 7000 psi/g/cc is required, more preferably at least about 8000 psi/g/cc for the carbon foam precursor.

The inventive carbon foam, prior to activation, should have a relatively uniform distribution of pores in order to provide the required high compressive strength. In addition, the pores should be relatively isotropic, by which is meant that the pores are relatively spherical, meaning that the pores have, on average, an aspect ratio of between about 1.0 (which represents a perfect spherical geometry) and about 1.5. The aspect ratio is determined by dividing the longer dimension of any pore with its shorter dimension.

The foam should have a total porosity of about 65% to about 95%, more preferably about 70% to about 95%. In addition, it has been found highly advantageous to have a bimodal pore distribution, that is, a combination of two average pore sizes, with the primary fraction being the larger size pores and a minor fraction of smaller size pores. Preferably, of the pores, at least about 90% of the pore volume, more preferably at least about 95% of the pore volume should be the larger size fraction, and at least about 1% of the pore volume, more preferably from about 2% to about 10% of the pore volume, should be the smaller size fraction.

The larger pore fraction of the bimodal pore distribution in the inventive carbon foam should be about 10 to about 150 microns in diameter, more preferably about 15 to about 95 microns in diameter, most preferably about 25 to about 95 microns in diameter. The smaller fraction of pores should comprise pores that have a diameter of about 0.8 to about 3.5 microns, more preferably about 1 to about 2 microns. The bimodal nature of the inventive foams provide an intermediate structure between open-celled foams and closed-cell foams, thus limiting the liquid permeability of the foam while maintaining a foam structure. Indeed, advantageously, the inventive carbon foams should exhibit a permeability of no greater than about 3.0 darcys, more preferably no greater than about 2.0 darcys (as measured, for instance, by ASTM C577).

Advantageously, to produce the inventive foams, a polymeric foam block, particularly a phenolic foam block, is carbonized in an inert or air-excluded atmosphere, at temperatures which can range from about 500° C., more preferably at least about 800° C., up to about 1200° C. to prepare a carbon foam for subsequent activation. The foam is then activated by heating the foam in a reactive atmosphere such as air, oxygen, steam, and/or carbon dioxide, with steam and carbon dioxide being the most preferred reactive atmospheres as these atmospheres are the most readily controllable. The activation temperature can range from about 300° C. to about 900° C. with about 500 to about 700° C. being preferable.

An object of the invention is to provide a carbon foam having an improved surface area which enables it to be employed for applications including filtration, food and chemical processing, waste water treatment, gasoline emission control, gas separation, gas storage, molecular sieves, and catalyst supports.

Another object of the invention, therefore, is a monolithic carbon foam having characteristics which enable it to be employed for use as a molecular sieve.

Still another object of the invention is a carbon foam having a porosity, cell structure and surface area enabling use of the foam as a supercapacitor.

Yet another object of the invention is a carbon foam which can be produced in a desired size and configuration, and which can be readily machined or joined to provide larger carbon foam structures.

Another object of the invention is to provide a method of producing the inventive carbon foam.

These aspects and others that will become apparent to the artisan upon review of the following description can be accomplished by providing a carbon foam article produced using a polymeric foam, such as a phenolic resol, formed by polymerization in either the presence of a metal oxidation catalyst or inorganic chemical activating agent selected to greatly improve the surface area of the finished, activated carbon foam.

The precursor carbon foam, the foam prior to activation, has a ratio of compressive strength to density of at least about 7000 psi/g/cc, especially a ratio of compressive strength to density of at least about 8000 psi/g/cc. The inventive foam product advantageously has a density of from about 0.05 to about 0.4 and a compressive strength of at least about 2000 psi, and a porosity of between about 65% and about 95%. The pores of the carbon foam have, on average, an aspect ratio of between about 1.0 and about 1.5. The activation results in a burn-off of material resulting in a degradation of strength. Therefore, a high strength carbon foam precursor is necessary for achieving an active carbon foam with sufficient strength for use as a monolith without the use of a binder.

Preferably, at least about 90% of the pore volume of the pores have a diameter of between about 10 and about 150 microns; indeed, most preferably at least about 95% of the pore volume of the pores have a diameter of between about 25 and about 95 microns. Advantageously, at least about 1% of the pore volume of the pores have a diameter of between about 0.8 and about 3.5 microns, more preferably, from about 2% to about 10% of the pore volume of the pores have a diameter of about 1 to about 2 microns.

The inventive foam can be produced by first carbonizing a polymer foam article, especially a phenolic foam, in an inert or air-excluded atmosphere. The phenolic foam should preferably have a compressive strength of at least about 100 psi. The carbon foam is then heated in a reactive atmosphere to substantially increase the foam's surface area, thus activating the foam. The activated foam should preferably have a surface area of from about 200 m²/g to about 3000 m²/g. This can be achieved by inducing a weight loss of from about 20% to about 50% in the thermal activation process.

It is to be understood that both the foregoing general description and the following detailed description provide embodiments of the invention and are intended to provide an overview or framework of understanding to nature and character of the invention as it is claimed.

### DETAILED DESCRIPTION OF THE PREFERRED EMBODIMENTS

Carbon foams in accordance with the present invention are prepared from polymeric foams, such as polyurethane foams or phenolic foams, with phenolic foams being preferred. Phenolic resins are a large family of polymers and oligomers, composed of a wide variety of structures based on the reaction products of phenols with formaldehyde. Phenolic resins are prepared by the reaction of phenol or substituted phenol with an aldehyde, especially formaldehyde, in the presence of an acidic or basic catalyst. Phenolic resin foam is a cured system composed of open and closed cells. The resins are generally aqueous resoles catalyzed by sodium hydroxide at a formaldehyde:phenol ratio which can vary, but is preferably about 2:1. Free phenol and formaldehyde content should be low, although urea may be used as a formaldehyde scavenger.

The foam is prepared by adjusting the water content of the resin and adding a surfactant (eg, an ethoxylated nonionic), a blowing agent (eg, pentane, methylene chloride, or chlorofluorocarbon), and a catalyst (eg, toluenesulfonic acid or phenolsulfonic acid). The sulfonic acid catalyzes the reaction, while the exotherm causes the blowing agent, emulsified in the resin, to evaporate and expand the foam. The surfactant controls the cell size as well as the ratio of open-to-closed cell units. Both batch and continuous processes are employed. In the continuous process, the machinery is similar to that used for continuous polyurethane foam. The properties of the foam depend mainly on density and the cell structure.

The preferred phenol is resorcinol, however, other phenols of the kind which are able to form condensation products with aldehydes can also be used. Such phenols include monohydric and polyhydric phenols, pyrocatechol, hydroquinone, alkyl substituted phenols, such as, for example, cresols or xylenols; polynuclear monohydric or polyhydric phenols, such as, for example, naphthols, p.p′-dihydroxydiphenyl dimethyl methane or hydroxyanthracenes.

The phenols used to make the foam starting material can also be used in admixture with non-phenolic compounds which are able to react with aldehydes in the same way as phenol.

The preferred aldehyde for use in the solution is formaldehyde. Other suitable aldehydes include those which will react with phenols in the same manner. These include, for example, acetaldehyde and benzaldehyde.

In general, the phenols and aldehydes which can be used in the process of the invention are those described in U.S. Pat. Nos. 3,960,761 and 5,047,225, the disclosures of which are incorporated herein by reference.

In order to optimize the process for achieving an activated carbon foam with a high surface area, the inventive foam should be prepared with an oxidization promoting metal or metal containing compound dispersed throughout the foam's structure. The oxidation promoting metal-containing additive catalyzes the oxidation process and increases the surface area of the carbon foam by facilitating the creation of various mesopores, micropores, and submicropores throughout the foam's structure. Specifically, the oxidation promoting metal-containing additive facilitates the development of high surface area during the oxidation of the carbon foam while still maintaining the integrity of the foam's monolithic structure. The precursor foam can still be thermally activated without the presence of an incorporated metal to achieve about a 20-50% weight loss but the process is much less efficient.

By use of an oxidation promoting metal-containing additive, the precursor carbon foam will have many more reactive sites, which greatly enhances the development of high surface area with a controlled porosity. Optimally, the inventive carbon foam will have about 0.1% to about 1.0% of an oxidation promoting metal-containing additive dispersed throughout its molecular structure. These metals include catalysts, metal oxides, and metal chlorides containing sodium, potassium, calcium and zinc. Preferably, the oxidation promoting metal-containing additive contains an alkali metal such as sodium and less preferably is selected from the alkaline earth metals.

The preferred method for incorporating an oxidation promoting metal-containing additive into a carbon foam is to introduce the additive during the formation of the precursor resin. For instance, an oxidation catalyst such as sodium hydroxide can be used as a polymerization catalyst for the phenol-formaldehyde polymerization in the production of a phenolic novolac resin. Other metal-containing catalysts containing potassium, calcium, or zinc could also be incorporated into the carbon foam precursor in a similar manner. Additionally, if a basic polymerization catalyst is used in the production of a phenolic resol resin which does not contain an oxidization promoting metal, an oxidation promoting metal-containing acid can be added subsequent to the resin formation to neutralize excess base catalyst. In either the acid or base catalyzed resin formation, the oxidation promoting metal is dispersed throughout the resin and becomes part of the phenolic foam and eventually the carbon foam.

In another embodiment, an oxidation promoting metal-containing additive can be incorporated into a carbon foam during the conversion of the phenolic resin to a phenolic foam. Specifically, the oxidation promoting metal can be introduced as an inorganic chemical activating agent in the form of a metal oxide or a metal chloride. The inorganic chemical activating agent should contain sodium, potassium, zinc or other metals known in the art to oxidize carbon. When exposed to a reactive atmosphere, the agent causes pitting in the surface of the carbon foam resulting in the formation of a ramified pore system throughout the carbon foam. This pore system exposes an extremely high surface area of activated carbon that can bind a wide variety of chemical substances through adsorption.

To activate carbon foam created with either an oxidation catalyst or inorganic chemical activating agent, the carbon foam should be heat treated in a reactive atmosphere subsequent to the carbonization process. The treatment of such carbon foam with air, ozone, steam or carbon dioxide at temperatures of from about 300° C. to about 800° C. will lead to activated carbon foam with surface areas of 200 m²/g or higher. With the optimization of both the temperature and atmospheric conditions, surface areas in excess of 1000 m²/g can be achieved.

The final concentration of the oxidation promoting metal in the carbon foam preferably should be from about 0.1% to about 1.5% by weight. The concentration of metal in the foam is determined from elemental analysis using the Inductively Coupled Plasma (ICP) technique as described in ASTM D5600. To achieve the preferred concentration of the oxidation promoting metal-containing additive in the carbon foam material, the concentration of the additive in the phenolic foam should be from about 0.2% to about 3.0% by weight because the yield for conversion of phenolic foam to carbon foam is approximately about 50%. This conversion yield will result in the desired concentration of about 0.1% to about 1.5% by weight of the the oxidation promoting metal-containing additive in the carbon foam material upon carbonization of the phenolic foam.

The polymeric foam precursor prepared as described above, used as the starting material in the production of the inventive carbon foam should have an initial density which mirrors the desired final density for the carbon foam which is to be formed. In other words, the polymeric foam should have a density of about 0.1 to about 0.6 g/cc, more preferably about 0.1 to about 0.4 g/cc. The cell structure of the polymeric foam should be closed with a porosity of between about 65% and about 95% and a relatively high compressive strength, i.e., on the order of at least about 100 psi, and as high as about 300 psi or higher.

In order to convert the polymeric foam to carbon foam, the foam is carbonized by heating to a temperature of from about 500° C., more preferably at least about 600, up to about 1200° C., in an inert or air-excluded atmosphere, such as in the presence of nitrogen. The heating rate should be controlled such that the polymer foam is brought to the desired temperature over a period of several days, since the polymeric foam can shrink by as much as about 50% or more during carbonization. Care should be taken to ensure uniform heating of the polymer foam piece for effective carbonization.

By use of a polymeric foam heated in an inert or air-excluded environment, a non-graphitizing glassy carbon foam is obtained, which has the approximate density of the starting polymer foam, but a compressive strength of at least about 2000 psi and, significantly, a ratio of strength to density of at least about 7000 psi/g/cc, more preferably at least about 8000 psi/g/cc. The carbon foam has a relatively uniform distribution of isotropic pores having, on average, an aspect ratio of between about 1.0 and about 1.5. Notably, non-graphitizing carbon such as the aforementioned carbon foam is much more reactive to oxidizing gases because non-graphitized carbon contains many more edge sites where predominant reaction occurs (P. L. Walker et al. Chemistry and Physics of Carbon Vol. 1, 328 (1965)).

The resulting carbon foam has a total porosity of about 65% to about 95%, more preferably about 70% to about 95% with a bimodal pore distribution; at least about 90%, more preferably at least about 95%, of the pore volume of the pores are about 10 to about 150 microns in diameter, more preferably about 15 to about 95 microns in diameter, most preferably about 25 to about 95 microns in diameter, while at least about 1%, more preferably about 2% to about 10%, of the pore volume of the pores are about 0.8 to about 3.5 microns, more preferably about 1 to about 2 microns, in diameter. The bimodal nature of the inventive foam provides an intermediate structure between open-celled foams and closed-cell foams, limiting the liquid permeability of the foam while maintaining a foam structure. Permeabilities less than 3.0 darcys, even less than 2.0 darcys, are preferred.

In order to convert the carbon foam to an activated carbon foam, the foam is activated by heating to a temperature of from about 300° C., up to about 800° C., in a reactive atmosphere, such as an atmosphere comprising carbon dioxide, steam, ozone, oxygen, or air. Both the heating rate and atmospheric conditions should be controlled to obtain the desired surface area of the activated carbon foam. The proper thermal and atmospheric conditions will create a ramified pore system throughout the carbon foam, resulting in a large internal specific surface area. Specifically, by heating a carbon foam containing about 0.8% sodium at 590° C. for about twenty minutes, a weight loss of about 29% can be achieved while a heat treatment of the same foam at 590° C. for about forty minutes will lead to a weight loss of about 40%.

In general, it is desired to remove from 20-40% of the original carbon foam weight to achieve surface areas in excess of 500 m²/g. By use of an oxidation catalyst or an inorganic chemical agent coupled with a heat treatment in a reactive atmosphere, an activated carbon foam is obtained, which has a surface areas over 700 m²/g.

Typically, characteristics such as porosity and individual pore size and shape are measured optically, such as by use of an epoxy microscopy mount using bright field illumination, and are determined using commercially available software, such as Image-Pro Software available from MediaCybernetic of Silver Springs, Md.

Accordingly, by the practice of the present invention, carbon foams having heretofore unrecognized characteristics are prepared. These foams exhibit exceptional high surface areas as well as high compressive strength to density ratios and have a distinctive structure, making them uniquely effective for a variety of applications including filtration, food and chemical processing, waste water treatment, gasoline emission control, gas separation, gas storage, molecular sieves, and catalyst supports. Alternatively, the activated carbon foam could also be used as a supercapacitor.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A method for creating an activated carbon foam, which comprises the steps of:
a) polymerizing a phenol-aldehyde mixture with a metal-containing oxidation catalyst to form a metal-containing resin article;
b) foaming the metal-containing resin article to create a metal-impregnated phenolic foam;
c) carbonizing the metal-impregnated phenolic foam to create an oxidizable carbon foam;
d) heating the oxidizable carbon foam in a reactive atmosphere to create an activated carbon foam.

2. The method of claim 1 wherein the metal-containing oxidation catalyst is sodium hydroxide.

3. The method of claim 1 wherein the metal-containing oxidation catalyst includes an oxidation promoting metal containing additive selected from the group consisting of sodium, potassium, alkaline earth metals, zinc and combinations thereof.

4. The method of claim 1 wherein step d) comprises heating the oxidizable carbon foam to a temperature of from about 500° C. to about 1000° C.

5. The method of claim 1 wherein the reactive atmosphere of step d) is air.

6. The method of claim 1 wherein the reactive atmosphere of step d) is carbon dioxide.

7. The method of claim 1 wherein the reactive atmosphere of step d) is ozone.

8. The method of claim 1 wherein the reactive atmosphere of step d) is oxygen.

9. The method of claim 1 wherein the reactive atmosphere of step d) is steam.

10. The method of claim 1 wherein the activated carbon foam has a surface area of from about 200 m²/g to about 3000 m²/g.

11. A method for creating activated carbon foam, which comprises the steps of:
a) mixing an inorganic chemical activating agent with a resin precursor to create a mixed resin precursor;
b) producing a phenolic foam from the mixed resin precursor;
c) carbonizing the phenolic foam to create an oxidizable carbon foam;
d) heating the oxidizable carbon foam in a reactive atmosphere to create an activated carbon foam.

12. The method of claim 11 wherein the inorganic chemical activating agent is a metal oxide.

13. The method of claim 11 wherein the inorganic chemical activating agent is a metal chloride.

14. An activated carbon foam comprising a carbon foam with a surface area of from about 200 m²/g to about 3000 m²/g.

15. The foam of claim 14 wherein the surface area of the carbon foam is from about 700 m²/g to about 2000 m²/g.

16. The foam of claim 14 further comprising an oxidation promoting metal-containing additive dispersed through the carbon foam's structure.

17. The foam of claim 16 wherein the oxidation promoting metal-containing additive is a metal oxide.

18. The foam of claim 16 wherein the oxidation promoting metal-containing additive is a metal chloride.

19. The foam of claim 16 wherein the metal of the oxidation promoting metal-containing additive is selected from the group consisting of sodium, potassium, zinc, alkaline earth metals, and combinations thereof.

20. The foam of claim 16 wherein the activated carbon foam has an oxidation promoting metal-containing additive content of from about 0.1 to about 1.5 by weight.

21. An activated carbon foam exhibiting a weight-loss of about 25% to about 50% when compared to the same carbon foam in an unactivated condition.
